(19) United States
(12) Patent Application Publication
(10) Pub. No.: US 2019/0073853 A1
(43) Pub. Date: Mar. 7, 2019

(54) PAPER SHEET ACCOMMODATION APPARATUS AND PAPER SHEET ACCOMMODATION METHOD

(71) Applicant: Fujitsu Frontech Limited, Tokyo (JP)

(72) Inventors: Tatsuya Shimamura, Inagi (JP); Hayato Minamishin, Tokyo (JP); Yutaka Namikawa, Inagi (JP)

(73) Assignee: Fujitsu Frontech Limited, Tokyo (JP)

(21) Appl. No.: 16/184,381

(22) Filed: Nov. 8, 2018

Related U.S. Application Data
(63) Continuation of application No. PCT/JP2016/065815, filed on May 27, 2016.

(51) Int. Cl. G07D 11/00; B65H 29/00

(52) U.S. Cl. CPC G07D 11/0021; B65H 2701/1912; B65H 29/006

(57) ABSTRACT

A paper sheet accommodation apparatus includes: a supply reel which supplies a wound band-like material; a winding drum around which a paper sheet is wound together with the band-like material that is supplied from the supply reel; and a roller member which is disposed along an axial direction of the winding drum and presses the band-like material and the paper sheet that are wound around the winding drum against the winding drum. The roller member includes a first roller portion in contact with the band-like material, and a second roller portion in contact with the paper sheet in the axial direction of the winding drum.

### CROSS-REFERENCE TO RELATED APPLICATION

This application is a continuation application of International Application PCT/JP2016/065815, filed on May 27, 2016 and designating the U.S., the entire contents of which are incorporated herein by reference.

### FIELD

The present invention relates to a paper sheet accommodation apparatus and a paper sheet accommodation method.

### BACKGROUND

A banknote handling apparatus included in an automated teller machine (ATM) includes a banknote accommodation apparatus that temporarily accommodates deposited banknotes. As such a kind of banknote accommodation apparatus, a configuration, in which a banknote is wound around a winding drum together with a tape that is supplied from a supply reel, is known. In the banknote accommodation apparatus, for example, a plurality of pulleys, which support the tape that is supplied from the supply reel, are arranged along a traveling path of the tape such that a predetermined tension is applied to the tape that is wound around the winding drum by each of the pulleys.

Patent Literature 1: Japanese Laid-open Patent Application No. 2013-199365

However, in the paper sheet accommodation apparatus described above, there may be cases where deformation such as wrinkling or bending occurs in a banknote that is wound around the winding drum. In such a case, the wound state of the banknote that is wound around the winding drum, varies depending on the deformed state of the banknote, and thus the stability of the wound state of the banknote is insufficient. In the winding drum, there is concern that the number of banknotes, which can be wound around the winding drum, may decrease as the wound state of the banknote changes.

### SUMMARY

According to an aspect of the embodiments, a paper sheet accommodation apparatus includes: a supply reel which supplies a wound band-like material;

a winding drum around which a paper sheet is wound together with the band-like material that is supplied from the supply reel; and a roller member which is disposed along an axial direction of the winding drum, and presses the band-like material and the paper sheet that are wound around the winding drum against the winding drum, wherein the roller member includes a first roller portion in contact with the band-like material, and a second roller portion in contact with the paper sheet in the axial direction of the winding drum.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic view illustrating the entirety of a banknote handling apparatus including a banknote accommodation apparatus of a first embodiment.

FIG. 2 is a perspective view illustrating the banknote accommodation apparatus of the first embodiment.

FIG. 3 is a plan view illustrating a roller member included in the banknote accommodation apparatus of the first embodiment.

FIG. 4 is a perspective view illustrating a modification example of a first roller portion of the roller member.

FIG. 5A is a side view illustrating an initial state of a winding drum of the banknote accommodation apparatus of the first embodiment.

FIG. 5B is a sectional view illustrating a state in which a banknote is wound around the winding drum of the banknote accommodation apparatus of the first embodiment.

FIG. 6 is a perspective view illustrating a banknote accommodation apparatus of a second embodiment.

FIG. 7 is a perspective view illustrating a roller member and a guide member included in the banknote accommodation apparatus of the second embodiment.

FIG. 8 is a plan view illustrating the roller member included in the banknote accommodation apparatus of the second embodiment.

FIG. 9A is a side view illustrating an initial state of a winding drum of the banknote accommodation apparatus of the second embodiment.

FIG. 9B is a sectional view illustrating a state in which a banknote is wound around the winding drum of the banknote accommodation apparatus of the second embodiment.

### DESCRIPTION OF EMBODIMENTS

Hereinafter, embodiments of a paper sheet accommodation apparatus and a paper sheet accommodation method disclosed in this application, will be described in detail with reference to the drawings. The paper sheet accommodation apparatus and the paper sheet accommodation method disclosed in this application are not limited by the following embodiments.

### First Embodiment

[Configuration of Banknote Handling Apparatus]

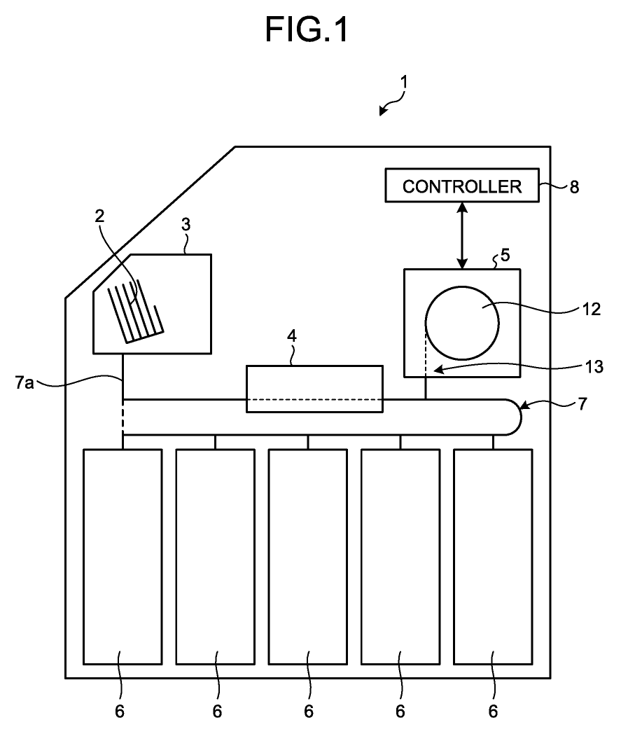

FIG. 1 is a schematic view illustrating the entirety of a banknote handling apparatus including a banknote accommodation apparatus of an embodiment. As illustrated in FIG. 1, a banknote handling apparatus 1 according to the embodiment includes a deposit and withdrawal unit 3 for deposits and withdrawals of a banknote 2, a discriminating unit 4 which discriminates the authenticity of the banknote 2 deposited into the deposit and withdrawal unit 3, and a temporary accommodation unit 5 which temporarily accommodates the banknote 2 that is transported from the discriminating unit 4. In addition, the banknote handling apparatus 1 includes a plurality of storage units 6 which store the banknote 2 that is sent from the temporary accommodation unit 5, a transport mechanism 7 which transports the banknote 2, and a controller 8 which controls each of the units 3, 4, 5, 6, and 7. The transport mechanism 7 has a transport path 7a on which the banknotes 2 is transported between the units 3, 4, 5, and 6. The temporary accommodation unit 5 assembled into the banknote handling apparatus 1 corresponds to the banknote accommodation apparatus of the embodiment. Hereinafter, the temporary accommodation unit 5 will be described as a banknote accommodation apparatus 5. In this embodiment, the banknote 2 is used as an example of paper sheets, but the paper sheet is not limited to a banknote. Examples of paper sheets include securities such as promissory notes, checks, gift certificates, various securities, and stock certificates.

[Configuration of Banknote Accommodation Apparatus]

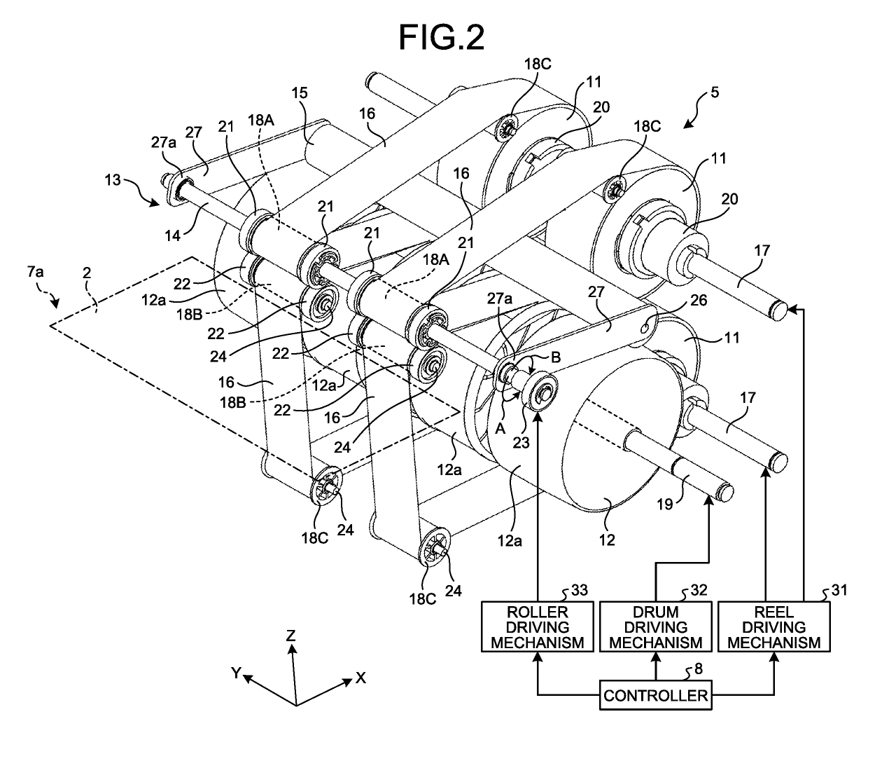

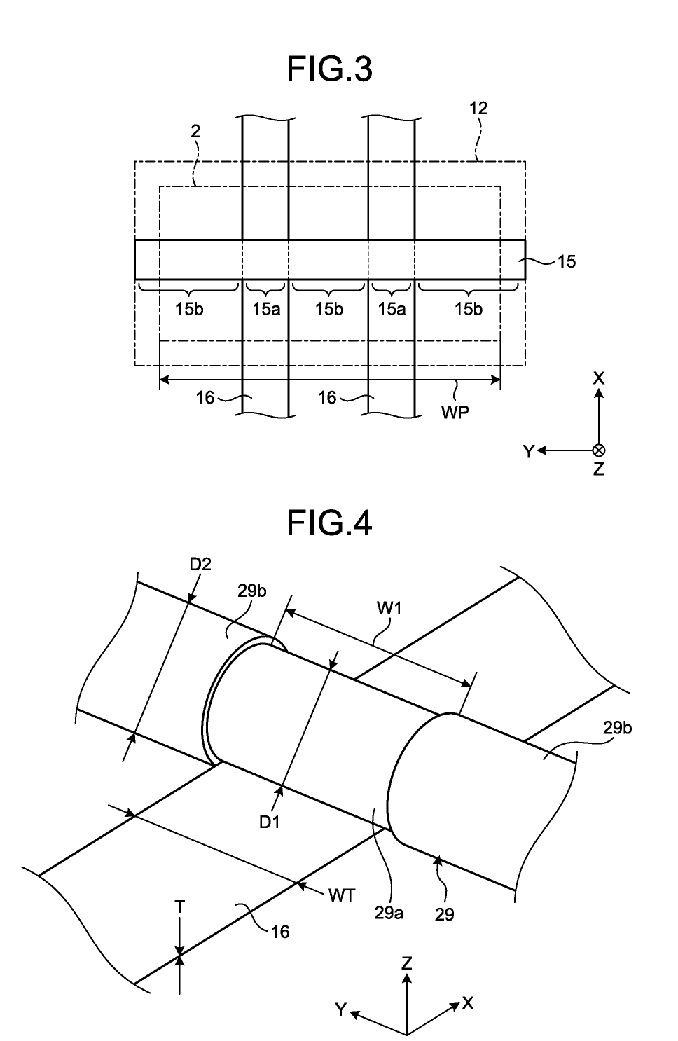

FIG. 2 is a perspective view illustrating the banknote accommodation apparatus of a first embodiment. FIG. 3 is a plan view illustrating a roller member included in the banknote accommodation apparatus of the first embodiment. FIG. 4 is a perspective view illustrating a modification example of a first roller portion of the roller member.

As illustrated in FIG. 2, the banknote accommodation apparatus 5 of the first embodiment includes two sets of supply reels 11, a winding drum 12, a taking in and out section 13, a rotating shaft 14, and a roller member 15. For convenience of description, in FIG. 2, the direction, in which the banknote 2 enters and leaves the taking in and out section 13, is referred to as an X direction, the axial direction of the winding drum 12 is referred to as a Y direction, and the vertical direction of the banknote accommodation apparatus 5, illustrated in FIG. 2, is referred to as a Z direction. In FIG. 3 and the following figures, similarly to FIG. 2, the X, Y, and Z directions are illustrated.

Each of the supply reels 11 supplies a tape 16 as a wound band-like material. In the two sets of supply reels 11, the two supply reels 11, which are disposed above the winding drum 12, are supported on a common reel shaft 17 and are disposed with a predetermined interval therebetween in the axial direction of the winding drum 12. Similarly, the two supply reels 11, which are disposed below the winding drum 12, are supported on a common reel shaft 17 and are disposed with a predetermined interval therebetween in the axial direction of the winding drum 12. A traveling path of the tape 16 is formed between each of the supply reels 11 and the winding drum 12, and a plurality of pulleys 18C are disposed on the traveling path of the tape 16. Each of the pulleys 18C is rotatably supported by a support shaft 24, and supports the tape 16 so as to move along the traveling path. In addition, each of the supply reels 11 is supported on the reel shaft 17 via a torque limiter 20, and the tension, which is generated in the tape 16, is limited to a predetermined tension or less.

The winding drum 12 is supported by a support shaft 19. As an example, the winding drum 12, illustrated in FIG. 2, has a plurality of drum portions 12a that are separated in the axial direction (Y direction) of the support shaft 19 but is not limited to this configuration, and the drum portions 12a may be formed continuously in the axial direction. The banknote 2 is wound around the winding drum 12 together with the tape 16 that is supplied from each of the supply reels 11. Specifically, in a state in which the banknotes 2 are held between the tapes 16, by interposing the banknotes 2 between the two tapes 16, which are sent through the upper side of the winding drum 12, and the two tapes 16, which are sent through the lower side of the winding drum 12, the banknotes 2 are wound around the winding drum 12 together with the tapes 16.

As illustrated in FIG. 1, the taking in and out section 13 is provided adjacent to the transport path 7a, and the banknote 2 is taken in and out between the transport path 7a and the banknote accommodation apparatus 5. The rotating shaft 14 is disposed in the taking in and out section 13, and a plurality of pulleys 18A, which support the tapes 16, are rotatably provided, and a plurality of transport rollers 21, which transport the banknotes 2 relative to the winding drum 12, are fixed. In addition, a drive transmission member 23 such as a pulley, on which a driving belt is hung, is fixed to one end of the rotating shaft 14 in order to cause the rotating shaft 14 to be driven to rotate by a roller driving mechanism 33, which will be described later.

The pulley 18A is rotatably supported on the rotating shaft 14 via a bearing member (not illustrated) such as a bearing. The transport rollers 21 are disposed adjacent to both sides of the pulley 18A in the axial direction (Y direction) of the rotating shaft 14. The diameter of the transport roller 21 is set to be slightly larger than the diameter of the pulley 18A, for example. As the transport roller 21, for example, a rubber roller is used.

In the taking in and out section 13, as illustrated in FIG. 2, a pulley 18B and a driven roller 22 are provided to be respectively paired with each of the pulleys 18A and each of the transport rollers 21, which are supported on the rotating shaft 14 at facing positions in the Z directions. The pulley 18B and the driven roller 22 are rotatably supported by the support shafts 24 via bearing members (not illustrated) such as bearings. A support stay (not illustrated) is fixed in the vicinity of the taking in and out section 13, and both ends of the support shaft 24 are supported by the support stay. The driven roller 22 rotates along with the transport roller 21 as the transport roller 21 rotates.

In addition, as illustrated in FIG. 2, in a case where the banknote 2, which is taken in from the taking in and out section 13, is wound around the winding drum 12, the rotating shaft 14 rotates in an A direction such that the transport roller 21 is rotated in the direction, in which the banknote 2 is wound around the winding drum 12. On the other hand, in a case where the banknote 2, which is wound around the winding drum 12, is taken out of the taking in and out section 13, the rotating shaft 14 rotates in a B direction such that the transport roller 21 is rotated in the direction, in which the banknote 2 is unwound around the winding drum 12 (hereinafter, referred to as unwinding direction).

As illustrated in FIGS. 2 and 3, the roller member 15 is disposed along the axial direction (Y direction) of the winding drum 12 to press the tape 16 and the banknote 2, which are wound around the winding drum 12 against the winding drum 12. As illustrated in FIG. 3, the roller member 15 has a plurality of first roller portions 15a in contact with the tape 16 and a plurality of second roller portions 15b in contact with the banknote 2 in the axial direction of the winding drum 12. In other words, the roller member 15 includes the second roller portion 15b which presses the banknote 2, which is a part other than the tape 16, against the winding drum 12 in the axial direction of the winding drum 12 to restrict swelling of a part of the banknote 2, which is not pressed by the tape 16, in the radial direction of the winding drum 12. In the roller member 15 in the first embodiment, the first roller portion 15a and the second roller portion 15b are uniformly, integrally formed of a resin material in an elongated cylindrical shape.

As illustrated in FIG. 3, the roller member 15 is disposed across the two tapes 16, which are respectively supplied from the supply reels 11 that are disposed along the axial direction of the winding drum 12. In addition, the roller member 15 is disposed across both sides of the banknote 2, which is wound around the winding drum 12, in the axial direction of the winding drum 12 to press the banknote 2 against the winding drum 12 over the entire width WP of the banknote 2 in the Y direction. In addition, the roller member 15 is disposed in a space between the tape 16, which is supplied from the upper side of the winding drum 12 toward the pulley 18A of the rotating shaft 14, and the tape 16, which is folded back over the pulley 18A of the rotating shaft 14 and is wound around the winding drum 12, on the traveling path of the tape 16.

Both end portions of the roller member 15 are rotatably supported by the distal end portions of a pair of swinging arms 27 via a support shaft 26, and the support shaft 26 of the roller member 15 and the support shaft 19 of the winding drum 12 are disposed parallel to each other. Base end portions 27a of the pair of swinging arms 27 are supported at both end portions of the rotating shaft 14 so as to be rotatable in the A and B directions around the rotating shaft 14. Furthermore, for example, both end portions of the rotating shaft 14 are provided with biasing members (not illustrated) such as torsion springs for biasing the roller member 15 that is supported by the swinging arms 27 toward the winding drum 12. The biasing force of the biasing member is set to obtain a pressing force for causing the first roller portions 15a and the second roller portions 15b of the roller member 15 to appropriately press the tape 16 and the banknote 2 against the winding drum 12.

In addition, the fulcrum of the swinging arm 27, that is, the relative position between the rotating shaft 14 and the support shaft 26, and the biasing force of the biasing member are appropriately set so that the pressing position of the roller member 15 in contact with the winding drum 12 does not greatly change between the start and the end of a winding operation, and a change in the pressing position due to a change in the outer diameter of the winding drum 12 is in a predetermined range. The rotating shaft 14 is not limited to the configuration using the biasing member, and the roller member 15 may be configured to be pressed against the winding drum 12 by the weights of the swinging arms 27 and the roller member 15.

The roller member 15, described above, is formed to be uniform in diameter in the axial direction of the roller member 15. However, alike a roller member 29 of a modification example illustrated in FIG. 4, the diameter D1 of a first roller portion 29a may be formed to be smaller than the diameter D2 of a second roller portion 29b depending on the thickness T of the tape 16. For example, the radius of the first roller portion 29a is formed to be smaller than the radius of the second roller portion 29b by the thickness T of the tape 16. Therefore, a step corresponding to the thickness of the tape 16 is formed between the first roller portion 29a and the second roller portion 29b. Accordingly, the load of the roller member 29, which is applied to the tape 16 wound around the winding drum 12 while overlapping the banknote 2, can be reduced, so that the damage to the tape 16 can be suppressed.

As illustrated in FIG. 4, in the roller member 29 of the modification example, the width W1 of the first roller portion 29a is formed to be larger than the width WT of the tape 16 in the axial direction (Y direction) of the winding drum 12. Accordingly, in the roller member 29, interference between the first roller portion 29a and both sides of the tape 16 in the width WT direction, is suppressed, the obstruction of movement of the tape 16 that is sent in the winding direction and the unwinding direction, is suppressed.

In the first embodiment, the tape 16, which is narrow, is used as an example of the band-like material, but the band-like material is not limited to the tape. In addition, in the first embodiment, the tape 16 made of a resin film is used but is not limited thereto, and if needed, a tape made of another material can also be used.

As illustrated in FIG. 2, the banknote accommodation apparatus 5 includes a reel driving mechanism 31 which drives the supply reels 11 to rotate, a drum driving mechanism 32 which drives the winding drum 12 to rotate, and the roller driving mechanism 33 which drives the transport roller 21 to rotate via the rotating shaft 14. Each of the reel driving mechanism 31, the drum driving mechanism 32, and the roller driving mechanism 33 is electrically connected to the controller 8. The reel driving mechanism 31 and the drum driving mechanism 32 have different rotational speeds, and perform a winding operation and an unwinding operation in a state where a constant tension is applied to the tape 16.

Furthermore, the roller driving mechanism 33 is driven in conjunction with the transport mechanism 7 that drives the transport path 7a. In this embodiment, the reel driving mechanism 31 and the roller driving mechanism 33 are driven by a common driving motor (not illustrated), and are configured to be reversibly rotatable individually via a switching gear or the like. The example is not limited to this configuration, and the reel driving mechanism 31 and the roller driving mechanism 33 may be separately driven by independent driving motors. Furthermore, the roller driving mechanism 33 may be driven by a driving motor that drives the transport mechanism 7.

[Banknote Accommodation Operation]

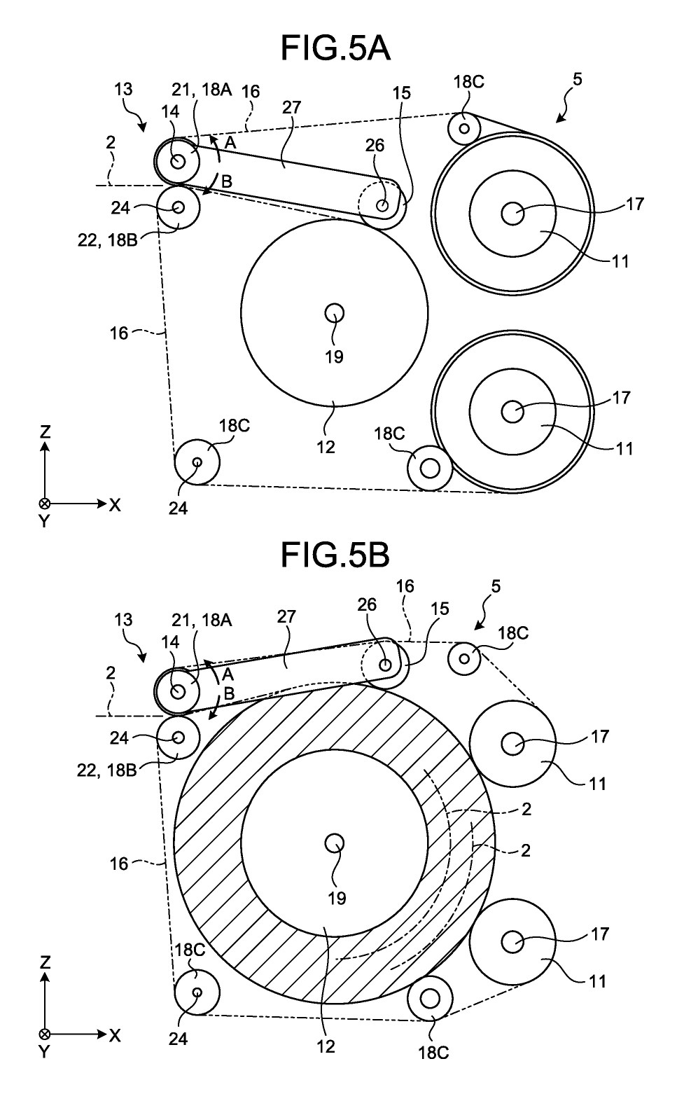

FIG. 5A is a side view illustrating an initial state of the winding drum 12 of the banknote accommodation apparatus 5 of the embodiment. FIG. 5B is a sectional view illustrating a state in which the banknote 2 is wound around the winding drum 12 of the banknote accommodation apparatus 5 of the embodiment.

In the banknote accommodation apparatus 5, as the banknote 2 is wound around the winding drum 12 together with the tape 16 from the initial state, in which the banknote 2 is not wound around the winding drum 12 as illustrated in FIG. 5A, the outer diameter of the entire winding drum 12 gradually increases as illustrated in FIG. 5B. As illustrated in FIGS. 5A and 5B, the banknote 2, which is taken in from the transport path 7a to the taking in and out section 13 of the banknote accommodation apparatus 5, is nipped between the transport roller 21 and the driven roller 22 and is sent. The banknote 2, which is sent by the transport roller 21 and the driven roller 22, is interposed between the tapes 16 that is respectively supplied from the supply reels 11, and is accommodated along the circumferential direction of the winding drum 12 together with the tapes 16. Here, the roller member 15 presses the tape 16, which is wound around the winding drum 12, against the winding drum 12 using the first roller portion 15a, and presses the banknote 2, which is wound around the winding drum 12, against the winding drum 12 using the second roller portion 15b.

The swinging arm 27 swings in the A direction around the rotating shaft 14, according to a change in the outer diameter of the entire winding drum 12, which is caused by the winding operation of the tapes 16 and the banknote 2, so that the state, in which the roller member 15 presses the tapes 16 and the banknote 2 against the winding drum 12, is maintained. In addition, the roller member 15 moves in the vertical direction (Z direction) in the space between the tape 16, which is supplied from the upper side of the winding drum 12 toward the pulley 18A of the rotating shaft 14, and the tape 16, which is folded back over the pulley 18A of the rotating shaft 14 and is wound around the winding drum 12.

The roller member 15 presses the banknote 2, which has deformation such as wrinkling or bending, using the second roller portion 15b such that the banknote 2 is appropriately wound along the circumferential direction of the winding drum 12 together with the tapes 16. Accordingly, the banknote 2 can be efficiently wound around the winding drum 12 while avoiding the occurrence of voids, bending, and the like between overlapping banknotes 2 in the radial direction of the winding drum 12.

[Banknote Accommodation Method]

In a banknote accommodation method using the banknote accommodation apparatus 5 configured as described above, the banknote 2 is wound around the winding drum 12 together with the tapes 16 that is supplied from the supply reels 11. In this banknote accommodation method, using the roller member 15 having the first roller portion 15a in contact with the tapes 16 and the second roller portion 15b in contact with the banknote 2 in the axial direction of the winding drum 12, the tapes 16 and the banknote 2, which are wound around the winding drum 12, are pressed against the winding drum 12.

As described above, the banknote accommodation apparatus 5 of the first embodiment includes the roller member 15 which includes the first roller portions 15a in contact with the tapes 16, and the second roller portions 15b in contact with the banknote 2 in the axial direction (Y direction) of the winding drum 12, and presses the tapes 16 and the banknote 2 that are wound around the winding drum 12 against the winding drum 12. Accordingly, even in a case where the banknote 2, which has deformation such as wrinkling or bending, is wound, it is possible to appropriately wind the banknote 2 around the winding drum 12 using the roller member 15, so that the stability of the wound state of the banknote 2 in the winding drum 12, can be increased. In addition, since the roller member 15 presses the banknote 2 using the second roller portion 15b, swelling of a part of the banknote 2, which is not pressed by the tape 16, in the radial direction of the winding drum 12 is restricted, and thus a broken part of the banknote 2 is prevented from being caught in the tape 16. Therefore, according to the banknote accommodation apparatus 5, the occurrence of voids, bending, and the like between overlapping banknotes 2 in the radial direction of the winding drum, 12 is suppressed, and thus it is possible to efficiently wound the banknote 2 around the winding drum 12 while avoiding a reduction in the number of sheets that can be wound around the winding drum 12.

In addition, according to the banknote accommodation apparatus 5, since the banknote 2 is appropriately wound around the winding drum 12, the reliability of the winding operation and the unwinding operation of the banknote 2, is increased. As a result, it is also possible to suppress the occurrence of jamming of the banknote 2 (hereinafter, referred to as jam) in the banknote accommodation apparatus 5 while avoiding the occurrence of deformation such as wrinkling in the banknote 2 that is wound around the winding drum 12. In addition, in the banknote accommodation apparatus 5, it is possible to closely wind the overlapping banknotes 2 that is around the winding drum 12 using the roller member 15 without winding the banknotes 2 around the winding drum 12 using the tape 16 to which a high tension is applied and without applying a load to the rotational driving force of the winding drum 12 due to the tension of the tape 16.

The roller member 15, which is included in the banknote accommodation apparatus 5 of the first embodiment, is disposed across both sides of the banknote 2 that is wound around the winding drum 12 in the axial direction of the winding drum 12. Accordingly, it is possible for the roller member 15 to press the banknote 2 over the entire width WP of the banknote 2, and the occurrence of a difference in the outer diameter between one end side and the other end side of the winding drum 12 in the axial direction, is suppressed. Therefore, the occurrence of wrinkling in the banknote 2 wound around the winding drum 12 due to the difference in the outer diameter, can be suppressed. In addition, it is possible for the roller member 15 to uniformly press the banknote 2 in the axial direction of the winding drum 12, and winding of a deformed banknote 2 in a skewed state or winding of the banknote 2 in a misaligned state in the circumferential direction of the winding drum 12, is suppressed. In addition, in a case where a difference in the outer diameter between one end side and the other end side of the winding drum 12 in the axial direction occurs, the pressing force of the side with a larger outer diameter becomes relatively large. Therefore, an effect of uniformizing the outer diameter of the winding drum 12, by correcting the difference in the outer diameter in the axial direction of the winding drum 12, is obtained. Therefore, the stability of the wound state of the banknote 2 in the winding drum 12, can be further increased.

According to the roller member 29 of the modification example, the diameter D1 of the first roller portion 29a is smaller than the diameter D2 of the second roller portion 29b. By decreasing the diameter D1 of the first roller portion 29a according to the thickness T of the tape 16, it is possible to reduce the load applied to the tape 16, which is wound around the winding drum 12 while overlapping the banknote 2, and the damage to the tapes 16 can be suppressed.

Hereinafter, a second embodiment will be described with reference to the drawings. In the second embodiment, the same constituent members as those in the first embodiment are denoted by the same reference numerals as those in the first embodiment, and the description thereof will be omitted. The second embodiment is different from the first embodiment in that the roller member is supported by a guide member.

### Second Embodiment

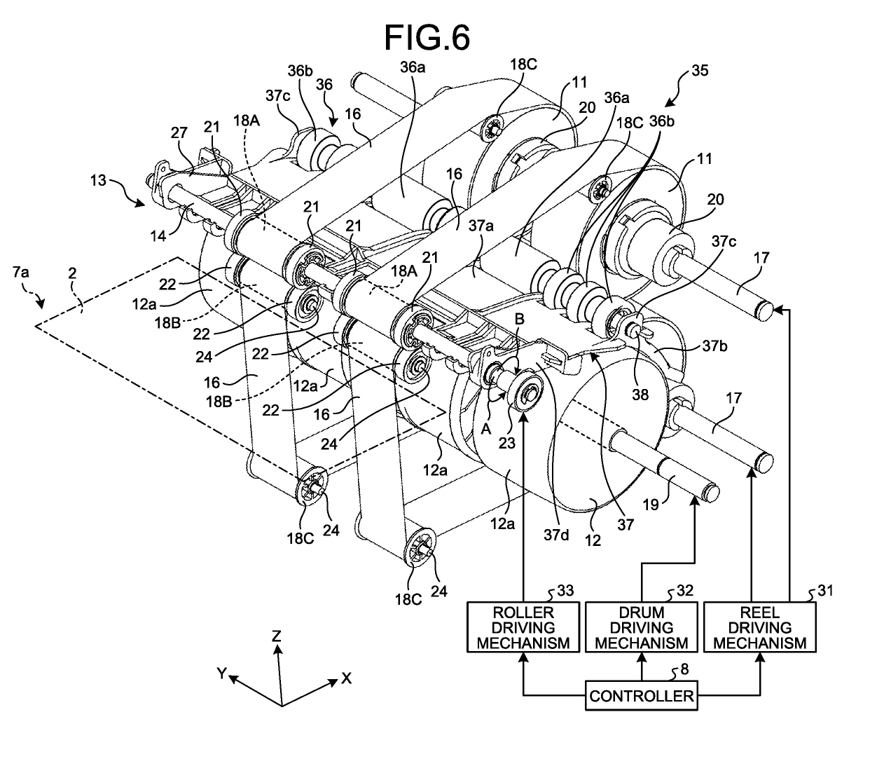

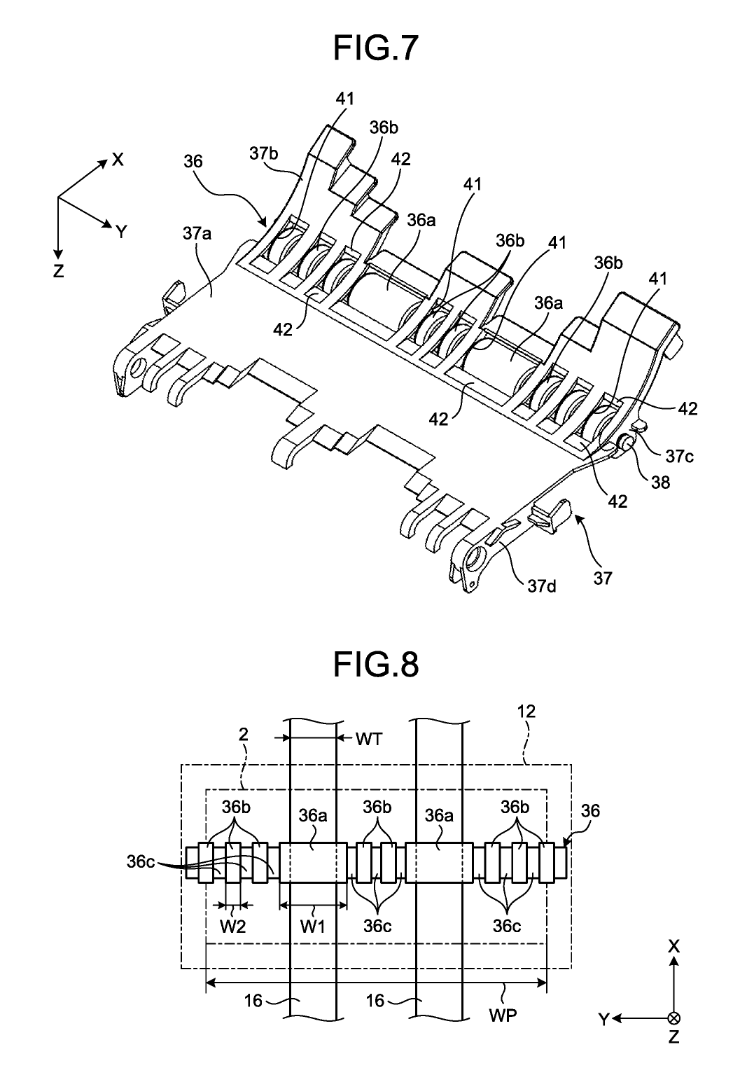

FIG. 6 is a perspective view illustrating a banknote accommodation apparatus of the second embodiment. FIG. 7 is a perspective view illustrating a roller member and a guide member included in the banknote accommodation apparatus of the second embodiment. In addition, FIG. 7 is a perspective view of the guide member according to the second embodiment as viewed from the facing surface side of the guide member facing the winding drum 12. FIG. 8 is a plan view illustrating the roller member included in the banknote accommodation apparatus of the second embodiment.

As illustrated in FIG. 6, a banknote accommodation apparatus 35 of the second embodiment includes a roller member 36 which presses the tape 16 and the banknote 2, and a guide member 37 which guides the banknote toward the winding drum 12.

The roller member 36 includes a plurality of first roller portions 36a in contact with the tape 16, and a plurality of second roller portions 36b in contact with the banknote 2. In the roller member 36, the first roller portions 36a and the second roller portions 36b are integrally formed of a resin material. As illustrated in FIG. 8, shaft portions 36c are formed between the first roller portions 36a and the second roller portions 36b, and are formed between the second roller portions 36b, and the first roller portion 36a and the second roller portion 36b are disposed with predetermined intervals therebetween.

As illustrated in FIG. 8, the roller member 36 is disposed across the two tapes 16, which are respectively supplied from the supply reels 11 that are disposed along the axial direction of the winding drum 12. In addition, the roller member 36 is disposed across both sides of the banknote 2, which is wound around the winding drum 12, in the axial direction of the winding drum 12 to press the banknote 2 against the winding drum 12 over the entire width WP of the banknote 2 in the Y direction.

The width W1 of the first roller portion 36a is formed to be larger than the width WT of the tape 16 in the axial direction (Y direction) of the winding drum 12. Accordingly, even in a case where the tape 16 swings in its width WT direction, the first roller portion 36a can appropriately press the entire width WT of the tape 16.

Similarly to the first roller portion 29a of the roller member 29 described above, the first roller portion 36a of the roller member 36 is formed to be smaller in diameter than the second roller portion 36b depending on the thickness T of the tape 16. For example, by setting the radius of the first roller portion 36a to be smaller than the radius of the second roller portion 36b by the thickness T of the tape 16, the load of the tape 16 pressed by the first roller portion 36a, is suppressed.

The guide member 37 guides the banknote 2 that is taken in from the taking in and out section 13 along the circumferential direction of the winding drum 12. As illustrated in FIGS. 6 and 7, the guide member 37 is formed of, for example, a resin material, and includes a flat portion 37a extending from the taking in and out section 13 side to the winding drum 12 side, and a curved portion 37b curved along the circumferential direction of the winding drum 12. Support portions 37c that support both end portions of the roller member 36, are formed in the curved portion 37b of the guide member 37. Both end portions of the roller member 36 are rotatably supported by the support portions 37c via a support shaft 38, and the support shaft 38 of the roller member 36 and the support shaft 19 of the winding drum 12, are disposed parallel to each other.

The end portions of the flat portion 37a of the guide member 37 are provided with arm portions 37d, which are supported by the rotating shaft 14, and are supported so as to be rotatable in the A and B directions around the rotating shaft. Furthermore, for example, both end portions of the rotating shaft 14 are provided with biasing members (not illustrated) such as torsion springs for biasing the roller member 36, which is supported by the guide member 37, toward the winding drum 12.

In addition, the guide member 37 and roller member 36 are disposed in a space between the tape 16, which is supplied from the upper side of the winding drum 12 toward the pulley 18A of the rotating shaft 14, and the tape 16, which is folded back over the pulley 18A of the rotating shaft 14 and is wound around the winding drum 12, on the traveling path of the tape 16.

In the curved portion 37b of the guide member 37, a plurality of openings 41, in which the roller member 36 is disposed, are provided with intervals therebetween along the axial direction (Y direction) of the winding drum 12. The openings 41 are formed so as to respectively correspond to the outer dimensions of the first roller portions 36a and the second roller portions 36b, and the first roller portions 36a and the second roller portions 36b are rotatably disposed in the openings 41.

As described above, in the roller member 36, it is possible to reduce the openings 41 of the guide member 37 in size by separating the first roller portions 36a and the second roller portions 36b from each other and by separating the second roller portions 36b into a plurality of second roller portions 36b. Accordingly, the gaps around the first roller portions 36a and the second roller portions 36b in the openings 41 are reduced in size, and end portions such as the corners of a deformed banknote 2 are prevented from entering the openings 41, so that the occurrence of a jam is suppressed.

Similarly, in the Y direction, the width W2 of the second roller portion 36b is formed to be smaller than the width W1 of the first roller portion 36a, and by reducing the second roller portion 36b in size, it is possible to reduce the openings 41 of the guide member 37 in size. Accordingly, the gaps around the first roller portions 36a and the second roller portions 36b in the openings 41 are reduced in size, and end portions such as the corners of a deformed banknote 2 are prevented from entering the openings 41, so that the occurrence of a jam is suppressed.

In addition, as illustrated in FIG. 7, in the facing surface of the guide member 37, which faces the winding drum 12, inclined surfaces 42, which are inclined with respect to the transport direction (X direction) of the banknote 2, are formed at the edge portions of the openings 41 by chamfering the corners of the edge portions of the openings 41. Since the inclined surfaces 42 are formed at the edge portions of the openings 41 as described above, a collision of an end portion such as the corner of the banknote 2, which is sent toward the winding drum 12 with the edge portion of the opening 41, is suppressed, and the occurrence of a jam in the opening 41 is suppressed.

[Banknote Accommodation Operation]

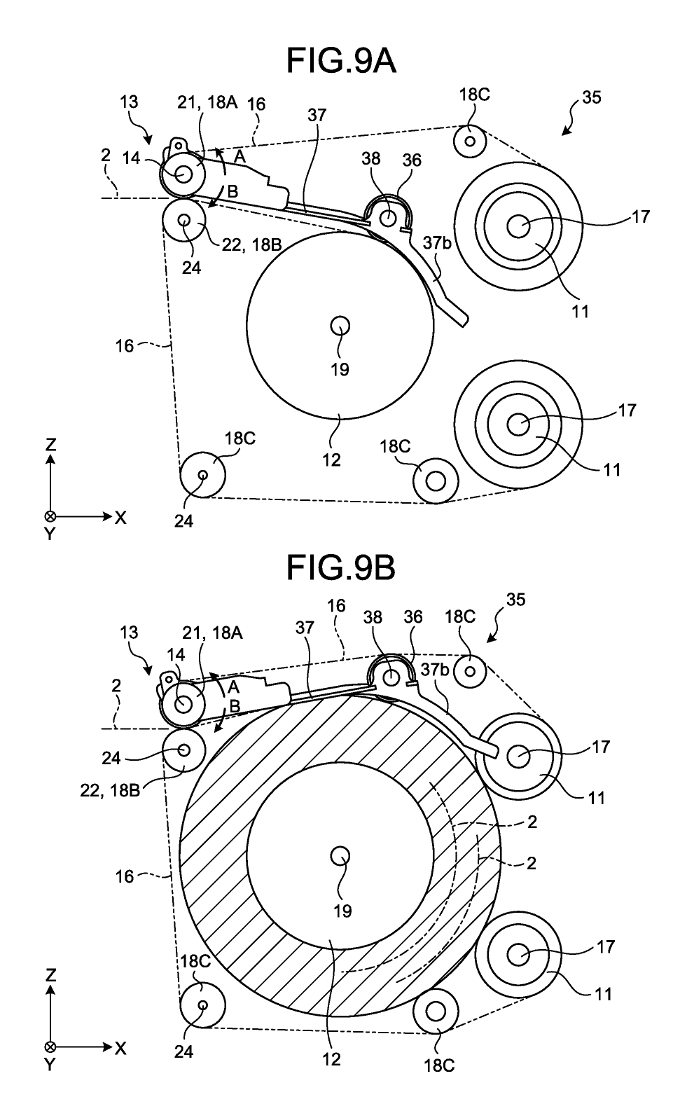

FIG. 9A is a side view illustrating an initial state of the winding drum 12 of the banknote accommodation apparatus 35 of the second embodiment. FIG. 9B is a sectional view illustrating a state in which the banknote 2 is wound around the winding drum 12 of the banknote accommodation apparatus 35 of the second embodiment.

Even in the banknote accommodation apparatus 35 of the second embodiment, as the banknote 2 is wound around the winding drum 12 together with the tape 16 from the initial state in which the banknote 2 is not wound around the winding drum 12 as illustrated in FIG. 9A, the outer diameter of the entire winding drum 12 gradually increases as illustrated in FIG. 9B. As illustrated in FIGS. 9A and 9B, the banknote 2, which is taken in from the transport path 7a to the taking in and out section 13 of the banknote accommodation apparatus 35, is nipped between the transport roller 21 and the driven roller 22 and is sent. The banknote 2, which is sent by the transport roller 21 and the driven roller 22, is interposed between the tapes 16, which are respectively supplied from the supply reels 11, and is accommodated along the circumferential direction of the winding drum 12 together with the tapes 16. Here, the roller member 36 presses the tape 16, which is wound around the winding drum 12 against the winding drum 12, using each of the first roller portions 36a, and presses the banknote 2, which is wound around the winding drum 12, against the winding drum 12 using the plurality of second roller portion 36b.

The guide member 37 swings in the A direction around the rotating shaft 14 according to a change in the outer diameter of the entire winding drum 12, caused by the winding operation of the tapes 16 and the banknote 2, so that the state, in which the roller member 36 presses the tapes 16 and the banknote 2 against the winding drum 12, is maintained. In addition, the roller member 36 moves in the vertical direction (Z direction) in the space between the tape 16, which is supplied from the upper side of the winding drum 12 toward the pulley 18A of the rotating shaft 14, and the tape 16, which is folded back over the pulley 18A of the rotating shaft 14 and is wound around the winding drum 12.

The roller member 36 presses the banknote 2, which has deformation such as wrinkling or bending, using the second roller portion 36b such that the banknote 2 is appropriately wound along the circumferential direction of the winding drum 12 together with the tapes 16. Accordingly, the banknote 2 can be efficiently wound around the winding drum 12 while avoiding the occurrence of voids, bending, and the like between overlapping banknotes 2 in the radial direction of the winding drum 12.

As described above, the banknote accommodation apparatus 35 of the second embodiment includes the roller member 36 which includes the first roller portions 36a in contact with the tapes 16, and the second roller portions 36b in contact with the banknote 2 in the axial direction (Y direction) of the winding drum 12, and presses the tapes 16 and the banknote 2 that are wound around the winding drum 12 against the winding drum 12. Accordingly, even in the second embodiment, as in the first embodiment, it is possible to appropriately wind the banknote 2 around the winding drum 12 using the roller member 36, so that the stability of the wound state of the banknote 2 in the winding drum 12, can be increased.

Furthermore, the banknote accommodation apparatus 35 includes the roller member 36 in which the first roller portions 36a and the second roller portions 36b are separated from each other, and the guide member 37 which guides the banknote 2 along the circumferential direction of the winding drum 12. The guide member 37 includes the plurality of openings 41 in which the first roller portions 36a and the second roller portions 36b are rotatably disposed. Accordingly, the openings 41 of the guide member 37 are reduced in size, and thus the gaps around the first roller portions 36a and the second roller portions 36b in the openings 41 are reduced in size, so that the occurrence of a jam, which is caused by the end portion of the deformed banknote 2 entering the opening 41 and being caught in the roller member 36, is suppressed.

In addition, in the roller member 36 included in the banknote accommodation apparatus 35, the width W1 of the first roller portion 36a is larger than the width WT of the tape 16 in the axial direction of the winding drum 12. Accordingly, deviation of the tape 16 from the first roller portion 36a is suppressed, and it is possible for the first roller portion 36a to appropriately press the entire width WT of the tape 16. Therefore, the stability of the wound state of the banknote 2 in the winding drum 12, can be further increased.

In the roller member 36 included in the banknote accommodation apparatus 35, the width W2 of the second roller portion 36b is smaller than the width W1 of the first roller portion 36a in the axial direction of the winding drum 12. Accordingly, the outer dimensions of the second roller portion 36b are reduced, and it is possible to reduce the openings 41 of the guide member 37, so that the occurrence of a jam in the openings 41 is suppressed.

In addition, in the facing surface of the guide member 37 included in the banknote accommodation apparatus 35, facing the winding drum 12, the inclined surfaces 42, which are inclined with respect to the transport direction (X direction) of the banknote 2, are formed at the edge portions of the openings 41 by chamfering the corners of the edge portions of the openings 41. Accordingly, a collision of the end portion such as the corner of the banknote 2 with the edge portion of the opening 41 of the guide member 37, is suppressed, and the occurrence of a jam in the opening 41 can be further suppressed.

In addition, in the first and second embodiments, the roller member 15 (36) is formed of a single material. However, the first roller portion 15a (36a) and the second roller portion 15b (36b) of the roller member 15 (36) may be formed of, for example, materials having different coefficients of friction depending on the tape 16 or the banknote 2 to be pressed.

According to the aspect of the banknote accommodation apparatus disclosed in this application, the stability of a wound state of the paper sheet in the winding drum can be increased.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet accommodation apparatus comprising:
a supply reel which supplies a wound band-like material;
a winding drum around which a paper sheet is wound together with the band-like material that is supplied from the supply reel; and
a roller member which is disposed along an axial direction of the winding drum, and presses the band-like material and the paper sheet that are wound around the winding drum against the winding drum,
wherein the roller member includes a first roller portion in contact with the band-like material, and a second roller portion in contact with the paper sheet in the axial direction of the winding drum.

2. The paper sheet accommodation apparatus according to claim 1,
wherein the roller member is disposed across both sides of the paper sheet that is wound around the winding drum in the axial direction of the winding drum.

3. The paper sheet accommodation apparatus according to claim 1, further comprising:
a guide member which guides the paper sheet along a circumferential direction of the winding drum,
wherein, in the roller member, the first roller portion and the second roller portion are separated from each other, and
the guide member includes a plurality of openings in which the first roller portion and the second roller portion are respectively, rotatably disposed.

4. The paper sheet accommodation apparatus according to claim 1,
wherein the paper sheet accommodation apparatus includes a plurality of the supply reels disposed along the axial direction of the winding drum, and
the roller member is disposed across a plurality of the band-like materials supplied from the plurality of the supply reels.

5. The paper sheet accommodation apparatus according to claim 1,
wherein a diameter of the first roller portion is smaller than a diameter of the second roller portion.

6. The paper sheet accommodation apparatus according to claim 1,
wherein a width of the first roller portion is larger than a width of the band-like material in the axial direction of the winding drum.

7. The paper sheet accommodation apparatus according to claim 1,
wherein a width of the second roller portion is smaller than a width of the first roller portion in the axial direction of the winding drum.

8. The paper sheet accommodation apparatus according to claim 3,
wherein, in a facing surface of the guide member, which faces the winding drum, an inclined surface is formed at an edge portion of the opening.

9. A paper sheet accommodation method comprising:
winding a paper sheet that is around a winding drum together with a band-like material supplied from a supply reel; and
pressing the band-like material and the paper sheet that are wound around the winding drum against the winding drum, using a roller member, which has, a first roller portion in contact with the band-like material, and a second roller portion in contact with the paper sheet in an axial direction of the winding drum.
